(19) United States
(12) Patent Application Publication
(10) Pub. No.: US 2026/0073535 A1
(43) Pub. Date: Mar. 12, 2026

(54) MULTIMODAL 3D OBJECT DETECTION AND TRACKING FOR DECENTRALIZED OBJECT FUSION

(71) Applicant: QUALCOMM Incorporated, San Diego, CA (US)

(72) Inventors: Konstantin Smirnov, Unterhaching (DE); Khaled Skairek, München (DE); Eugen Schaefer, Kitzingen (DE)

(21) Appl. No.: 19/320,430

(22) Filed: Sep. 5, 2025

Related U.S. Application Data
(60) Provisional application No. 63/693,573, filed on Sep. 11, 2024.

(51) Int. Cl. G06T 7/277; B60W 50/00; B60W 50/14

(52) U.S. Cl. CPC G06T 7/277; B60W 50/0097; B60W 50/14; B60W 2050/0022; B60W 2050/0052; B60W 2420/403; B60W 2420/408; B60W 2554/4041; G06T 2207/10028; G06T 2207/30252

(57) ABSTRACT

An example device for detecting objects includes a processing system configured to receive values from one or more sensors of a vehicle; calculate a normalized innovation squared (NIS) value using the values from the one or more sensors and a predicted state formed by an object tracking unit of the vehicle; determine weight values to be used to weight the values from the one or more sensors and the predicted state according to a comparison of the NIS value to one or more thresholds; and apply the weight values to the values from the one or more sensors and the predicted state to determine an updated state of positions of objects near the vehicle. The device may determine the weight values using a Kalman Filter or Covariance Intersection, based on a comparison of the NIS value to the thresholds.

This application claims the benefit of U.S. Provisional Application No. 63/693,573, filed Sep. 11, 2024, the entire contents of which are hereby incorporated by reference.

### TECHNICAL FIELD

This disclosure relates to artificial intelligence, particularly as applied to advanced driving assistance systems.

### BACKGROUND

Techniques are being researched and developed related to advanced driving assistance systems. For example, artificial intelligence and machine learning (AI/ML) systems are being developed and trained to determine how best to operate a vehicle according to applicable traffic laws, safety guidelines, external objects, roads, and the like. Using cameras to collect images, depth estimation is performed to determine depths of objects in the images. Depth estimation can be performed by leveraging various principles, such as calibrated stereo imaging systems and multi-view imaging systems.

Various techniques have been used to perform depth estimation. For example, test-time refinement techniques include applying an entire training pipeline to test frames to update network parameters, which necessitates costly multiple forward and backward passes. Temporal convolutional neural networks rely on stacking of input frames in the channel dimension and bank on the ability of convolutional neural networks to effectively process input channels. Recurrent neural networks may process multiple frames during training, which is computationally demanding due to the need to extract features from multiple frames in a sequence and does not reason about geometry during inference. Techniques using an end-to-end cost volume to aggregate information during training are more efficient than test-time refinement and recurrent approaches, but are still non-trivial and difficult to map to hardware implementations.

### SUMMARY

In general, this disclosure describes techniques for determining positions of objects in a real-world environment using images and light detection and ranging (LIDAR)-generated point clouds. In particular, an object tracking unit of an advanced driving assistance system (ADAS) may receive sensor data from, e.g., cameras, LIDAR, and/or RADAR units, as well as a predicted state. The object tracking unit may calculate a normalized innovation squared (NIS) value using the predicted state data and the sensor data. The object tracking unit may then compare the NIS value to one or more thresholds, e.g., a high threshold and a low threshold (where the high threshold is above the low threshold), to determine one or more weighting values. The weighting values may be omega_a and omega_b values that are applied to the sensor data and the predicted state to determine a new, estimated state representing new positions of objects near and around the vehicle. For example, if the NIS value is above the high threshold, the object tracking unit may determine the weighting values such that the weighting values add up to 1, e.g., per Covariance Intersection (CovInt). As another example, if the NIS value is below the low threshold, the object tracking unit may determine the weighting values such that the weighting values add up to 2, e.g., per a Kalman filter. In this manner, the advantages of both Kalman and CovInt can be realized based on the NIS value, which may improve object detection and tracking.

In one example, a method of tracking positions of objects near a vehicle includes: receiving values from one or more sensors of a vehicle; calculating a normalized innovation squared (NIS) value using the values from the one or more sensors and a predicted state formed by an object tracking unit of the vehicle; determining weight values to be used to weight the values from the one or more sensors and the predicted state according to a comparison of the NIS value to a threshold; and applying the weight values to the values from the one or more sensors and the predicted state to determine an updated state of positions of objects near the vehicle.

In another example, a device for tracking positions of objects near a vehicle includes: a memory; and a processing system implemented in circuitry, coupled to the memory, and configured to: receive values from one or more sensors of a vehicle; calculate a normalized innovation squared (NIS) value using the values from the one or more sensors and a predicted state formed by an object tracking unit of the vehicle; determine weight values to be used to weight the values from the one or more sensors and the predicted state according to a comparison of the NIS value to a threshold; and apply the weight values to the values from the one or more sensors and the predicted state to determine an updated state of positions of objects near the vehicle.

In another example, a computer-readable storage medium has stored thereon instructions that, when executed, cause a processing system to: receive values from one or more sensors of a vehicle; calculate a normalized innovation squared (NIS) value using the values from the one or more sensors and a predicted state formed by an object tracking unit of the vehicle; determine weight values to be used to weight the values from the one or more sensors and the predicted state according to a comparison of the NIS value to a threshold; and apply the weight values to the values from the one or more sensors and the predicted state to determine an updated state of positions of objects near the vehicle.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example vehicle including an advanced driving assistance system (ADAS) controller according to techniques of this disclosure.

FIG. 2 is a block diagram illustrating an example set of components of an ADAS controller according to techniques of this disclosure.

FIG. 3 is a block diagram illustrating an example set of components that may be included in a depth determination unit according to techniques of this disclosure.

FIGS. 4A-4C are conceptual diagrams illustrating an example depiction of a real world scene including vehicle 100 and objects around vehicle 100 at different times as vehicle 100 is moving.

FIG. 5 is a block diagram illustrating an example vehicle with a multi-camera system and an ADAS controller according to techniques of this disclosure.

FIG. 6 is a block diagram illustrating an example object tracking unit per techniques of this disclosure.

FIG. 7 is a flowchart illustrating an example method of tracking objects according to techniques of this disclosure.

FIG. 8 is a flowchart illustrating an example method for determining weighting values per the techniques of this disclosure.

### DETAILED DESCRIPTION

Depth estimation is an important component of advanced driving assistance systems (ADAS) or other systems used to partially or fully control a vehicle or other device, e.g., for robot navigation. Depth estimation may also be used for extended reality (XR) related tasks, such as augmented reality (AR), mixed reality (MR), or virtual reality (VR). Depth information is important for accurate 3D detection and scene representation. Depth estimation for such techniques may be used for ADAS, assistive robotics, augmented reality/virtual reality scene composition, image editing, or other such techniques. Other types of image processing can also be used for AD/ADAS or other such systems, such as semantic segmentation, object detection, or the like. ADAS-equipped vehicles may use various sensors such as light detection and ranging (LIDAR) units, RADAR units, and/or one or more cameras (e.g., monocular cameras, stereo cameras, or multi-camera arrays, which may face different directions).

Three-dimensional object detection (3DOD) may include generating a bird's eye view (BEV) representation of a three-dimensional space. That is, while cameras may capture images to the sides of a moving object, such as a vehicle, the camera data may be used to generate a bird's eye view perspective, i.e., a top-down perspective. Downstream tasks, such as object tracking and prediction, may benefit from a BEV representation. Some such techniques do not have a confidence measure at the feature level.

Center-based techniques, such as CenterPoint, may be used to predict the center points of objects in the BEV, then regress the 3D dimensions and orientation of the objects around those center points. However, these techniques may face challenges in accurately estimating the confidence of object detection features and handling object variability.

ADAS systems may generally receive information about a surrounding environment from multiple sensors (e.g., cameras, LIDAR units, and/or RADAR units). One approach to process sensor data is Decentralized Fusion, which includes two stages. First, raw data of each sensor is tracked by a sensor itself, resulting in sensor objects that are sent to an Object Fusion component of an ADAS system. Second, an Object Fusion component tracks sensor objects producing fused tracks to be used by ADAS customer functions. This approach leads to a situation when input information for the Object Fusion component becomes correlated, while the state-of-the-art object tracker used in ADAS, the Kalman Filter (KF), requires input data to be non-correlated.

This may lead to inconsistency of the fused tracks and to rigidness of KF (because KF underestimates covariance matrixes of fused tracks). An alternative object tracker used in ADAS is Covariance Intersection (CovInt). CovInt overcomes the problem of input data being correlated by overestimating covariance matrixes of fused tracks resulting in, first, significant decrease of performance, and second, high reactivity of CovInt. Thus, KF and CovInt are two extremum solutions.

Per techniques of this disclosure, a normalized innovation squared (NIS) value may be compared to one or more thresholds to determine weighting values. For example, there may be a high threshold and a low threshold. If the NIS value is above the high threshold, the weighting values may be determined using Covariance Intersection (CovInt). If the NIS value is below the low threshold, the weighting values may be determined using a Kalman filter (KF). Therefore, based on the NIS value (e.g., based on a degree of correlation of input information), the benefits of using either the Kalman filter or CovInt may be realized, which may improve performance of object detection and tracking.

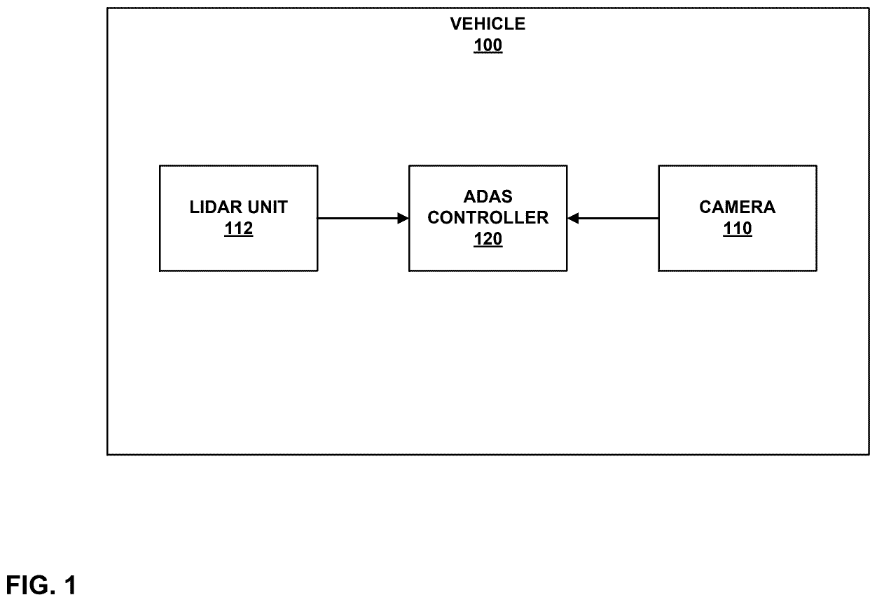

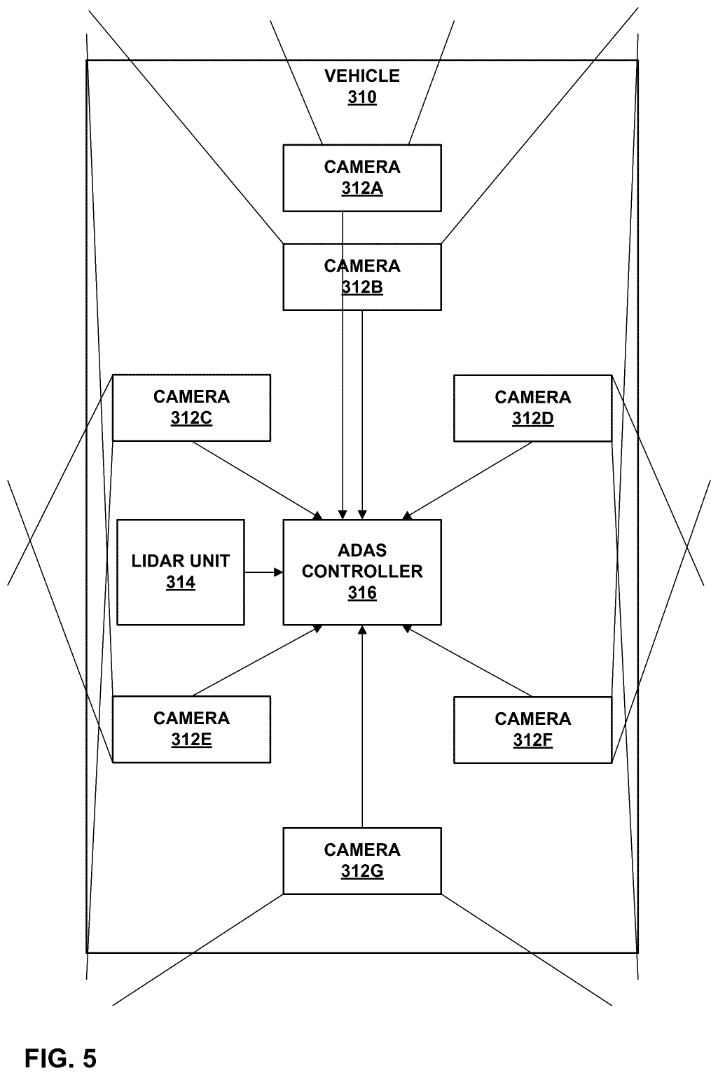

FIG. 1 is a block diagram illustrating an example vehicle 100 including an advanced driving assistance system (ADAS) controller 120 according to techniques of this disclosure. In this example, vehicle 100 includes camera 110, light detection and ranging (LIDAR) unit 112, and ADAS controller 120. Camera 110 is a single camera in this example. While only a single camera is shown in the example of FIG. 1, in other examples, multiple cameras may be used. However, the techniques of this disclosure allow for depth to be calculated for objects in images captured by camera 110 without additional cameras. In some examples, multiple cameras may be employed that face different directions, e.g., front, back, and to each side of vehicle 100, e.g., as shown in FIG. 5. ADAS controller 120 may be configured to calculate depth for objects captured by each of such cameras.

LIDAR unit 112 provides LIDAR data (e.g., point cloud data) for vehicle 100 to ADAS controller 120. LIDAR unit 112 may, for example, determine a point cloud for a three-dimensional area, where camera 110 also captures an image of the area. The point cloud may generally include points corresponding to surfaces or objects in the area identified by a light (e.g., laser) emitted by LIDAR unit 112 and reflected back to LIDAR unit 112. Based on the angle of emission of the light from LIDAR unit 112 and time taken for the light to traverse from LIDAR unit 112 to the object and back, LIDAR unit 112 can determine a three-dimensional coordinate for the point.

ADAS controller 120 receives image frames captured by camera 110 at a high frame rate, such as 30 fps, 60 fps, 90 fps, 120 fps, or even higher. ADAS controller 120 also receives point cloud data captured by LIDAR unit 112 at a corresponding rate, such that a point cloud is paired with the image frame (or frames of a multi-camera system). ADAS controller 120 may include a neural network trained to generate a depth map using fused features extracted from the frame(s) and the point cloud.

ADAS controller 120 may receive a point cloud or other such data structure from LIDAR unit 112 and image data from camera 110 at a current time. ADAS controller 120 may then extract relevant features for each time. The features can include occupancy information (e.g., whether a portion of the point cloud is occupied by an object or not), intensity values, color values, or local geometric descriptors for the LIDAR data. The features may also include camera features, such as color information, texture descriptors, or local image features. In this manner, the features may capture the visual characteristics of the image and corresponding LIDAR content.

ADAS controller 120 may also determine pose information for any or all of vehicle 100, LIDAR unit 112, and/or camera 110, e.g., using a global positioning system (GPS) unit. Determination of the pose information may indicate a position and orientation of vehicle 100, LIDAR unit 112, and/or camera 110 relative to the 3D scene. The pose data may include position and rotation information. The pose information may provide viewpoint information for subsequent 3D reconstruction of the 3D scene.

ADAS controller 120 may determine pose information and receive point cloud data and image data for a sequence of times. ADAS controller 120 may establish correspondences between voxel features across time steps t−1, t (where t represents a current time), and t+1 using the pose information, point cloud, and image data. ADAS controller 120 may then match voxel features across these time steps based on spatial proximity and similarity to identify corresponding voxels between the different time steps.

To establish voxel correspondence across different time steps, ADAS controller 120 may apply a spatial proximity criterion. ADAS controller 120 may compare voxel features from the current time step with features from the previous and/or next time step based on the spatial locations of the features. ADAS controller 120 may determine that voxel cells that are close in space and that have similar features between concurrent time steps potentially correspond. To determine distances between voxels, ADAS controller 120 may calculate Euclidean distance, which is calculated between voxel centroids or voxel centers of two voxels. The voxel cells with smaller Euclidean distances may be considered spatially close to each other. ADAS controller 120 may adjust the size of voxel grid cells to influence spatial proximity. Smaller voxel sizes may result in higher spatial resolution and more precise proximity determination.

ADAS controller 120 may use data received from LIDAR unit 112 and camera 110 to update an internal state representing objects detected near vehicle 100. Based on speed and direction of vehicle 100, ADAS controller 120 may predict a new state of the objects near vehicle 100. In addition, ADAS controller 120 may receive new sensor data from LIDAR unit 112 and camera 110 and update the internal state representing the objects detected (and being tracked) near vehicle 100.

In general, ADAS controller 120 may mathematically combine the sensor data and the predicted state, e.g., by weighting the sensor data and the predicted state. The weights may be referred to as alpha and beta, or omega_a and omega_b. In general, such weights represent how much impact the sensor data and the predicted state have on the updated state. Per the techniques of this disclosure, ADAS controller 120 may calculate a normalized innovation squared (NIS) value and compare the NIS value to one or more thresholds to determine the weighting values. For example, there may be a high threshold and a low threshold. If the NIS value is above the high threshold, ADAS controller 120 may determine the weighting values using Covariance Intersection (CovInt). If the NIS value is below the low threshold, ADAS controller 120 may determine the weighting values using a Kalman filter (KF).

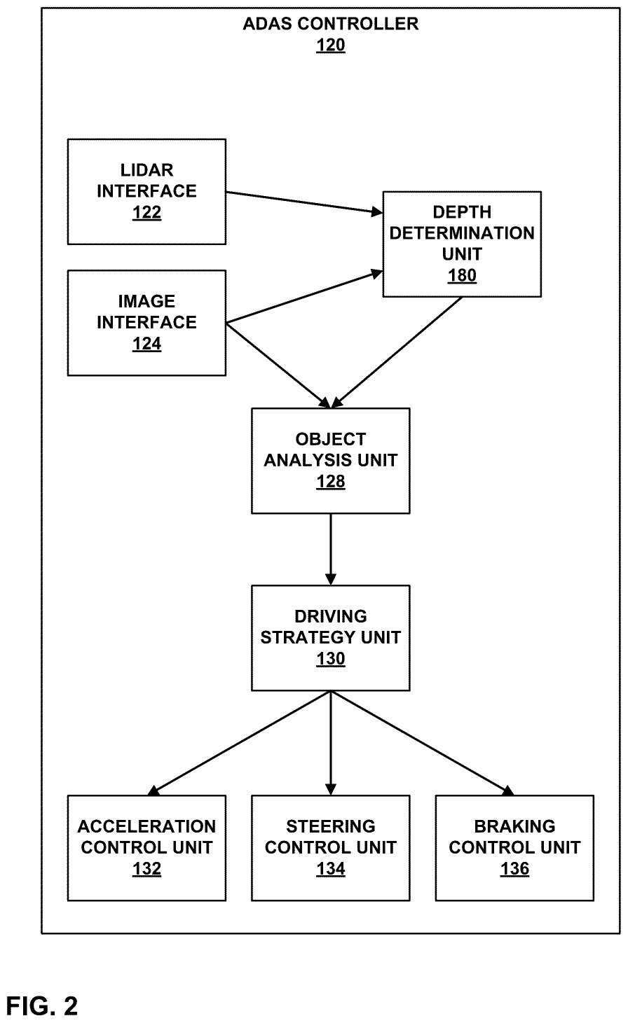

FIG. 2 is a block diagram illustrating an example set of components of ADAS controller 120 of FIG. 1 according to techniques of this disclosure. In this example, ADAS controller 120 includes LIDAR interface 122, image interface 124, depth determination unit 180, object analysis unit 128, driving strategy unit 130, acceleration control unit 132, steering control unit 134, and braking control unit 136.

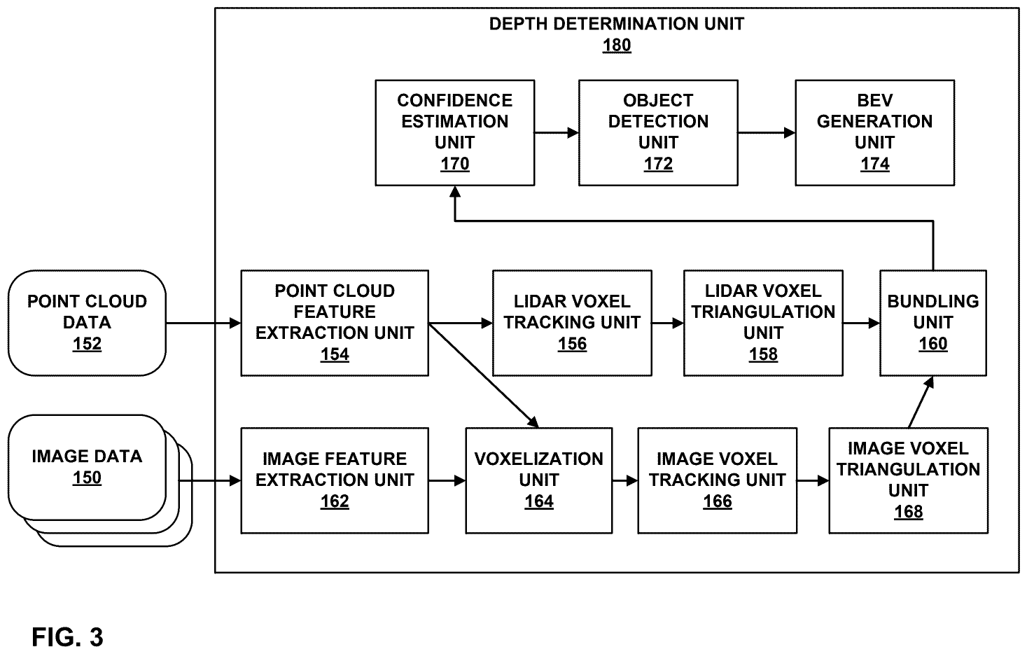

In general, LIDAR interface 122 represents an interface to LIDAR unit 112 of FIG. 1, which receives LIDAR data (e.g., point cloud data) from LIDAR unit 112 and provides the LIDAR/point cloud data to depth determination unit 180. In particular, as described in greater detail below with respect to FIG. 3, depth determination unit 180 may extract point cloud features from the point cloud data and image features from the image frame, fuse the image features with the point cloud features, and then determine a depth map from the fused features, e.g., using a neural network. To train the neural network, per the techniques of this disclosure, initially, a ground truth depth map may be used. The ground truth depth map may be a dense depth map, that is, substantially denser than the point cloud generated by and received from LIDAR unit 112 via LIDAR interface 122.

According to the techniques of this disclosure, depth determination unit 180 may receive both image data via image interface 124 and point cloud data via LIDAR interface 122 for a series of time steps. Depth determination unit 180 may further receive odometry information. Depth determination unit 180 may extract image features from the images and LIDAR/point cloud features (e.g., occupancy) for voxels in a 3D representation of a real world space. Depth determination unit 180 may extract such features for each time step in the series. Furthermore, depth determination unit 180 may determine correspondences between voxels in each time step to track movement of real world objects represented by the voxels over time. Such movement may be used to predict where the objects will be in the future, e.g., if vehicle 100 (FIG. 1) continues to move in a current direction or were to alter trajectory.

Image interface 124 may also provide the image frames to object analysis unit 128. Likewise, depth determination unit 180 may provide depth values for objects in the images to object analysis unit 128. Object analysis unit 128 may generally determine where objects are relative to the position of vehicle 100 at a given time, and may also determine whether the objects are stationary or moving. Per the techniques of this disclosure, over time, object analysis unit 128 may track objects based on movement of vehicle 100 using weighting values that are applied to sensor data (e.g., cameras, LIDAR data, and/or RADAR data) and to predicted state. In particular, object analysis unit 128 may determine the weighting values based on an NIS value compared to one or more threshold values. For example, if the NIS value is above a high threshold, object analysis unit 128 may determine the weighting values using CovInt and if the NIS value is below a low threshold, object analysis unit 128 may determine the weighting values using KF.

Object analysis unit 128 may provide object data to driving strategy unit 130, which may determine a driving strategy based on the object data. For example, driving strategy unit 130 may determine whether to accelerate, brake, and/or turn vehicle 100. Driving strategy unit 130 may execute the determined strategy by delivering vehicle control signals to various driving systems (acceleration, braking, and/or steering) via acceleration control unit 132, steering control unit 134, and braking control unit 136.

The various components of ADAS controller 120 may be implemented as any of a variety of suitable circuitry components, such as one or more microprocessors, digital signal processors (DSPs), application specific integrated circuits (ASICs), field programmable gate arrays (FPGAs), discrete logic, software, hardware, firmware, or any combinations thereof. When the techniques are implemented partially in software, a device may store instructions for the software in a suitable, non-transitory computer-readable medium and execute the instructions in hardware using one or more processors to perform the techniques of this disclosure.

FIG. 3 is a block diagram illustrating an example set of components that may be included in depth determination unit 180 of FIG. 2. In this example, depth determination unit 180 includes image feature extraction unit 162, point cloud feature extraction unit 154, LIDAR voxel tracking unit 156, LIDAR voxel triangulation unit 158, voxelization unit 164, image voxel tracking unit 166, image voxel triangulation unit 168, bundling unit 160, confidence estimation unit 170, object detection unit 172, and bird's eye view (BEV) generation unit 174.

Multi-modal inputs, such as image and point cloud/LIDAR inputs, may help to make more accurate predictions of depth maps, reduce reliance on a single sensor, and also address common issues such as sensor occlusion, e.g., if an object is obstructing one or more cameras and/or the LIDAR unit at a given time.

In this example, depth determination unit 180 receives one or more images in the form of image data (e.g., from one or more cameras, such as cameras in front, to the sides of, and/or to the rear of vehicle 100 of FIG. 1), and point cloud data 152. Point cloud feature extraction unit 154 extracts LIDAR features from the point cloud data, such as occupancy information or local geometric descriptors. Point cloud feature extraction unit 154 may then form a voxel representation from point cloud data 152. For example, point cloud feature extraction unit 154 may determine that voxels representing positions of objects exist in a 3D representation for each voxel corresponding to an occupied node of point cloud data 152.

Point cloud feature extraction unit 154 provides the voxel representation to voxelization unit 164 and LIDAR voxel tracking unit 156. LIDAR voxel tracking unit 156 may compare voxels and LIDAR features for the voxels between several time periods, e.g., t−1, t (a current time), and t+1, and determine correspondences between the voxels across time. For instance, if a voxel at time t−1 and a voxel at time t are spatially close to each other and share common sets of LIDAR features, LIDAR voxel tracking unit 156 may determine that those two voxels correspond to the same voxel. Likewise, if a voxel at time t−1, a voxel at time t, and a voxel at time t+1 are spatially close to each other and share common sets of LIDAR features, LIDAR voxel tracking unit 156 may determine that those three voxels correspond to the same voxel.

LIDAR voxel triangulation unit 158 may then calculate distances between the corresponding voxels and vehicle 100 at each time, then use the calculated distances and the position of vehicle 100 at each time to perform triangulation to determine depth information for real world objects represented by the voxels, relative to vehicle 100. By tracking features of voxels, correspondences between the voxels can be tracked over time, and therefore, LIDAR voxel triangulation unit 158 may perform triangulation according to the positions of corresponding voxels at various times to improve the depth estimation for each real world object represented by the voxels.

Likewise, voxelization unit 164 may apply image data to the voxels for each time step. In this manner, in addition to tracking LIDAR features, image features such as color information, texture descriptors, or local image features can be used to track correspondences between the voxels over time. Image voxel tracking unit 166 may determine correspondences between the voxels over time based on the image features. Image voxel triangulation unit 168 may then also perform triangulation to determine depth values for real world objects represented by the image voxels.

Triangulation, as performed by LIDAR voxel triangulation unit 158 and image voxel triangulation unit 168, may involve finding intersection points of lines or rays emanating from corresponding voxel features in different time steps. This process may result in the estimation of the 3D positions of the triangulated voxels at each time step.

Bundling unit 160 may receive the depth values as determined by both LIDAR voxel triangulation unit 158 and image voxel triangulation unit 168. Bundling unit 160 may then merge and refine the estimated 3D structure and camera poses. Bundling unit 160 may perform a bundle adjustment optimization process to adjust the positions of the 3D points (triangulated voxels) and camera poses to minimize reprojection error between observed features and corresponding projections. By optimizing both the voxel positions and the camera poses, the accuracy and consistency of the reconstructed 3D structure may be improved.

Bundling unit 160 may provide this set of data to confidence estimation unit 170, which may check for consistency across time frames in 3D voxel space to generate confidence values for the depth values. Confidence estimation unit 170 may compute the consistency of the reconstructed 3D voxel features across time steps (e.g., t−1, t, and t+1) to calculate the confidence of object detection. This can be done by measuring the reprojection error of the 3D voxel features through evaluation of the consistency of the reconstructed 3D structure across multiple frames. Higher consistency may indicate higher confidence in the presence and properties of objects in the scene.

Confidence estimation unit 170 may use an error measurement metric to determine the confidence of object detection. For example, the Euclidean distance between the projected voxel feature and the observed feature may be used. A smaller distance may represent a higher consistency and confidence in the object detection result. Other metrics, such as pixel-wise distance or robust Huber loss, can also be used to account for outliers and improve the robustness of the confidence estimation. For example, for each correspondence c in C, confidence estimation unit 170 may calculate the Euclidean distance d(c) between voxel features Vₜ and Vₜ₊₁ as:

$$d ( c ) = ‖ {V}_{t} ( c ) - {V}_{t + 1} ( c ) ‖$$

where d(c) is the distance between the two voxel features, Vₜ(c) and Vₜ₊₁(c), Vₜ(c) is the voxel feature at location c in the t^{th} frame, and Vₜ(c) is the voxel feature at location c in the t+1^{th} frame.

Based on the calculated reprojection errors, confidence estimation unit 170 may apply a thresholding mechanism to classify the confidence levels of the object detections. A predefined threshold may be set to distinguish between confident and uncertain detections. Object detections with reprojection errors below the threshold may be considered confident, indicating a high consistency between the projected voxel features and the observed 3D voxel features. Conversely, detections with reprojection errors above the threshold may be regarded as uncertain or potentially erroneous.

Confidence estimation unit 170 may perform a structure-based confidence estimation procedure. Confidence estimation unit 170 may compute an overlap between the 3D voxel features and an underlying ground truth structure in the scene. In some examples, to measure overlap, confidence estimation unit 170 may calculate an intersection over union (IoU) structure representing an IoU between the projected 3D bounding box of the voxel features and the ground truth bounding box. Higher values for the IoU structure may indicate better alignment between the voxel features and the ground truth structure, contributing to a higher confidence value.

Confidence estimation unit 170 may additionally or alternatively factor temporal consistency into the confidence value. For example, confidence estimation unit 170 may compute the Euclidean distance/Huber loss/L1 between a centroid of the 3D voxel features in the current frame (t) and corresponding centroids in the previous (t−1) and/or next (t+1) frames. These distances may be referred to as “dist_prev” and “dist_next,” respectively. Confidence estimation unit 170 may then calculate the temporal consistency as the sum of these distances: TemporalConsistency=dist_prev+dist_next. Lower values of temporal consistency may indicate more stable and consistent object detections across frames.

Moreover, confidence estimation unit 170 may calculate a final confidence value or score. Confidence estimation unit 170 may assign a confidence value or score to each object detected based on its reprojection error. This score may indicate the level of confidence associated with the detection. Lower reprojection errors may correspond to higher confidence scores, while higher errors may result in lower confidence scores. Confidence estimation unit 170 may assign confidence scores to the object detections based on the consistency measure, where higher consistency values may indicate higher confidence.

Confidence estimation unit 170 may compute a confidence estimation function, such as a linear mapping or a non-linear mapping, to convert the consistency measure into a confidence store. For example, a simple linear mapping of

$$ConfidenceScore = 1 - \frac{d ( c )}{max\_dist}$$

may be used. In this example, max_dist is the maximum possible distance between voxel features. The confidence score may range from 0 to 1, where 1 indicates high confidence and 0 indicates low confidence. By measuring the reproduction error of 3D voxel features on the BEV images, this technique may provide an assessment of the consistency and reliability of object detection. This allows for the identification of confident detections based on accurate alignment between the voxel features and the observed features in the BEV view.

Confidence estimation unit 170 may then perform fusion and aggregation. That is, confidence estimation unit 170 may combine the structure-based confidence, temporal consistency, and confidence values to obtain an overall confidence score. This can be done using a weighted combination, such as:

$$OverallConfidence = w 1 ⋆ Structure Confidence + w 2 ⋆ TemporalConsistency + w 3 ⋆ ConfidenceValue$$

In this equation, w1, w2, and w3 represent weighting factors that may control the influence of each confidence measure. The confidence value represents an additional confidence measure or score that may be specific to the application or context. By including the confidence value in the calculation, a more comprehensive assessment of the overall confidence of the 3D voxel features may be realized. The weighting factors w1, w2, and w3 all confidence estimation unit 170 to adjust the relative importance of each confidence measure based on their significance to the specific application or system requirements.

Object detection unit 172 may then determine what objects are represented by the voxels and their positions relative to vehicle 100. Finally bird's eye view (BEV) generation unit 174 may generate a BEV representation of real world objects around vehicle 100, which may be processed to perform, e.g., ADAS or the like.

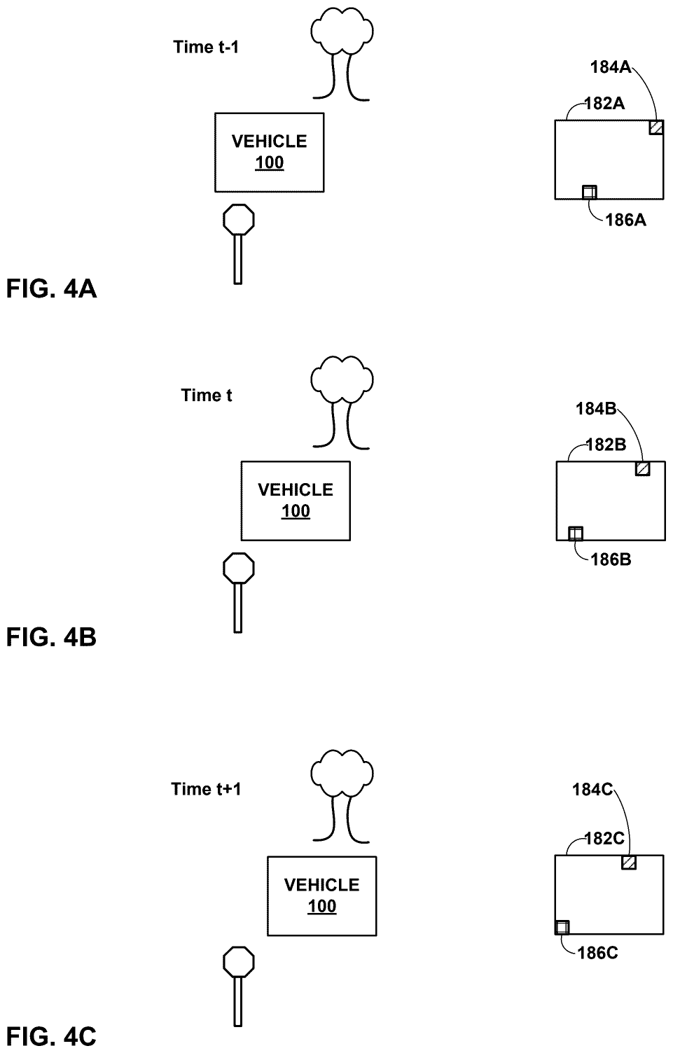

FIGS. 4A-4C are conceptual diagrams illustrating an example depiction of a real world scene including vehicle 100 and objects around vehicle 100 at different times as vehicle 100 is moving. FIGS. 4A-4C also depict voxel representations 182A-182C of the real world objects as may be generated using LIDAR features and/or image features of the objects. FIG. 4A depicts the scene at time t−1, in which voxel representation 182A includes voxels 184A and 186A. FIG. 4B depicts the scene at time t, in which voxel representation 182B includes voxels 184B and 186B. FIG. 4C depicts the scene at time t+1, in which voxel representation 182C includes voxels 184C and 186C.

Per the techniques of this disclosure, LIDAR features for voxels 184A, 184B, and 184C may generally be the same, e.g., have the same occupancy data. Additionally, image features for voxels 184A, 184B, and 184C may generally be the same, e.g., have the same color, texture information, or the like. Moreover, voxels 184A, 184B, and 184C are spatially close to each other across voxel representations 182A, 182B, and 182C. Therefore, voxels 184A, 184B, and 184C may be determined to correspond to the same real world object (e.g., a tree).

Similarly, LIDAR features for voxels 186A, 186B, and 186C may generally be the same, e.g., have the same occupancy data. Additionally, image features for voxels 186A, 186B, and 186C may generally be the same, e.g., have the same color information, texture information, or the like. Moreover, voxels 186A, 186B, and 186C are spatially close to each other across voxel representations 182A, 182B, and 182C. Therefore, voxels 186A, 186B, and 186C may be determined to correspond to the same real world object (e.g., a stop sign).

FIG. 5 is a block diagram illustrating an example vehicle 310 with a multi-camera system and ADAS controller 316 according to techniques of this disclosure. In particular, vehicle 310 includes cameras 312A-312G, and LIDAR unit 314. In this example, cameras 312A and 312B are front-facing cameras with different focal lengths, cameras 312C and 312D are side-rear facing cameras, cameras 312E and 312F are side-front facing cameras, and camera 312G is a rear-facing camera. In this manner, imagery can be captured by the collection of cameras 312A-312G for a 360 degree view around vehicle 310.

LIDAR unit 314 may generate LIDAR/point cloud data around vehicle 310 in 360 degrees. Thus, LIDAR/point cloud data may be generated for images captured by each of cameras 312A-312G. Both images and LIDAR data may be provided to ADAS controller 316.

ADAS controller 316 may include components similar to those of ADAS controller 120 of FIG. 2. For example, ADAS controller 316 may include a depth determination unit that performs the techniques of this disclosure, as discussed above, to extract features from the images and LIDAR data, fuse the extracted features, then generate a depth map from the fused features. In particular, ADAS controller 316 may track features extracted from images and LIDAR data over time, e.g., from consecutive frames, according to the techniques of this disclosure, to generate a BEV representation of a real-world space around vehicle 310. ADAS controller 316 may then use the BEV representation when making driving assistance decisions to control vehicle 310.

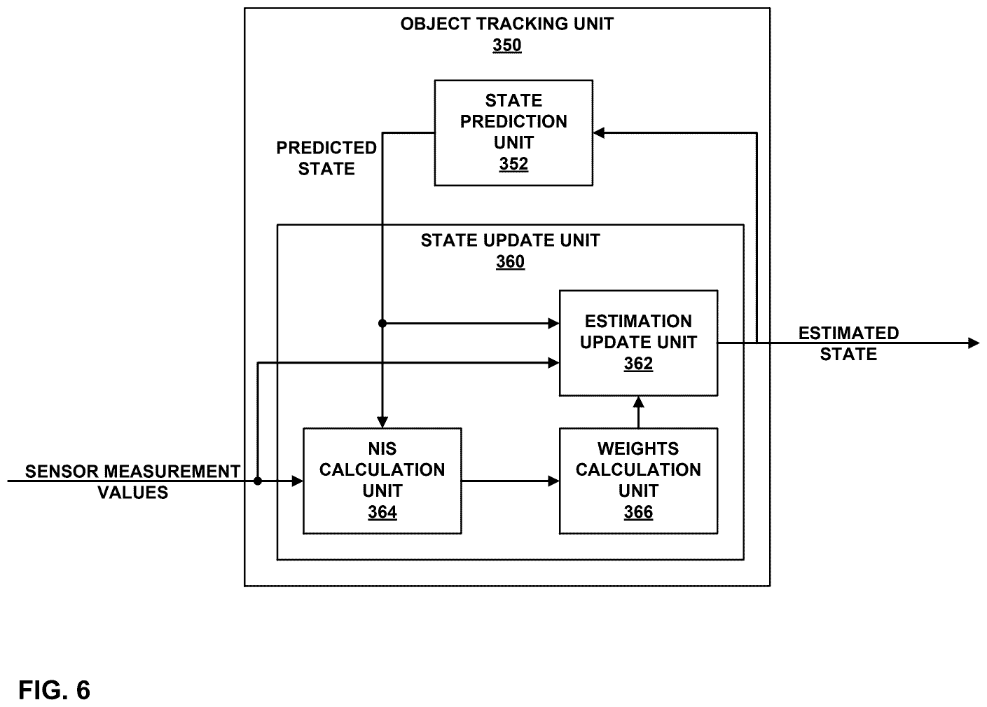

FIG. 6 is a block diagram illustrating an example object tracking unit 350 per techniques of this disclosure. In this example, object tracking unit 350 includes state prediction unit 352 and state update unit 360. State update unit 360 includes estimation update unit 362, normalized innovation squared (NIS) calculation unit 364, and weights calculation unit 366. Object tracking unit 350 may be included in, for example, ADAS controller 120 of FIG. 1 and/or object analysis unit 128 of FIG. 2.

Per the techniques of this disclosure, state prediction unit 352 may form a predicted state based on a current state and movement data of a vehicle (e.g., odometry data). State prediction unit 352 may provide a predicted state value to estimation update unit 362 and NIS calculation unit 364. NIS calculation unit 364 and estimation update unit 362 also receive sensor measurement values (e.g., image data, LIDAR data, and/or RADAR data). NIS calculation unit 364 calculates an NIS value using the sensor measurement values and the predicted state value.

Weights calculation unit 366 may receive the predicted state, sensor measurement values, and the NIS value. Per the techniques of this disclosure, weights calculation unit 366 may determine weight values based on the NIS value, e.g., by comparing the NIS value to one or more thresholds. That is, weights calculation unit 366 may determine a mode in which to determine the weights based on the NIS value and the one or more thresholds. In particular, object tracking unit 350 may be configured to fuse sensor objects (represented by the sensor measurement values) by constantly adapting the weights (e.g., omega_a and omega_b) individually for each fused track in a way that improves performance. As a decision factor for switching between tracker operating modes, NIS calculation unit 364 calculates an NIS value. The NIS value may generally measure an estimation capability of a tracker and may be influenced by both a quality of an estimation (e.g., predicted state) and consistency of the tracker. By applying an NIS hypothesis test, object tracking unit 350 may detect moments when the current operating mode is not optimal and switch to another mode that fits better.

The NIS value may be considered too big (e.g., higher than a high threshold) when either an innovation (pre-fit residual) is too big or innovation covariance is too small. The innovation may be considered too big when a difference between an internal prediction and a sensor measurement is big, which may occur, for example, when the tracked object changes a lane or decelerates. The innovation covariance may be too small when a tracker becomes overconfident. In the case that the NIS value is too big, weights calculation unit 366 may determine the weighting values (omega_a and omega_b for example) using CovInt or a CovInt like mode (where omega_a+omega_b equals 1) to make the tracker more reactive and to increase innovation covariance.

The NIS value may be considered too small (e.g., below a low threshold) when cither an innovation is small or innovation covariance is too big. In this situation, weights calculation unit 366 may use KF mode (where omega_a and omega_b are each equal to 1) to decrease innovation covariance (thus increasing tracker confidence).

In this manner, object tracking unit 350 of FIG. 6 represents an example of a device for tracking positions of objects near a vehicle, including: a memory; and a processing system implemented in circuitry, coupled to the memory, and configured to: receive values from one or more sensors of a vehicle; calculate a normalized innovation squared (NIS) value using the values from the one or more sensors and a predicted state formed by an object tracking unit of the vehicle; determine weight values to be used to weight the values from the one or more sensors and the predicted state according to a comparison of the NIS value to a threshold; and apply the weight values to the values from the one or more sensors and the predicted state to determine an updated state of positions of objects near the vehicle.

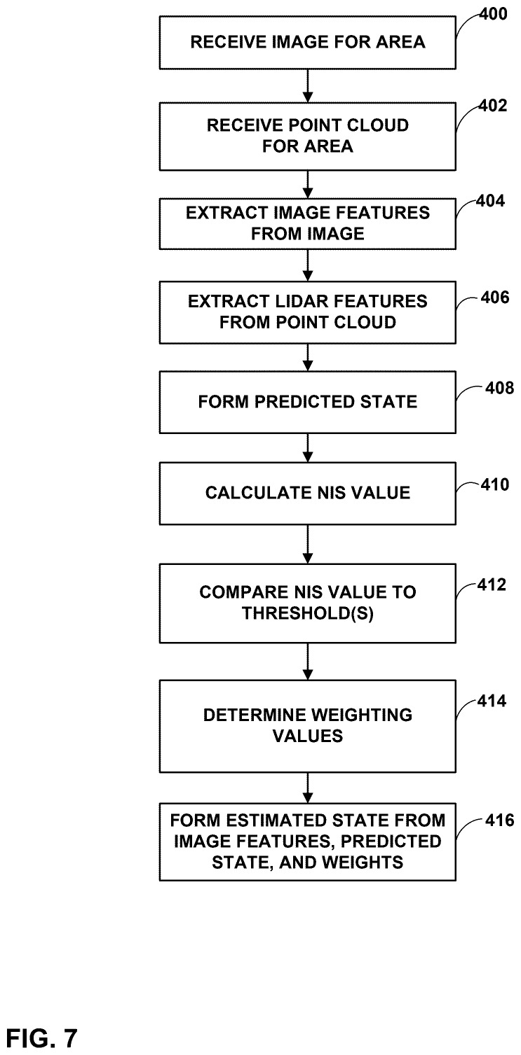

FIG. 7 is a flowchart illustrating an example method of tacking objects according to techniques of this disclosure. The method of FIG. 7 is described with respect to object tracking unit 350 of FIG. 6 for purposes of explanation. However, other units or devices may be configured to perform this or a similar method.

Initially, object tracking unit 350 receives an image for an area (400), e.g., an area around or near vehicle 100 (FIG. 1). Object tracking unit 350 also receives a point could cloud for the area (402), which may correspond to a point cloud generated by a LIDAR unit. The method of FIG. 7 represents the techniques of this disclosure as performed for a current time t. When performing these techniques, image and point cloud data is also collected for a previous frame at time t−1 and/or a next frame at time t+1, as discussed above. Object tracking unit 350 may extract image features from the image (404) and extract LIDAR features from the point cloud (406).

Object tracking unit 350 may then form a predicted state (408), e.g., based on a current state and odometry data of the vehicle. Object tracking unit 350 may also calculate a normalized innovation squared (NIS) value from the sensor data (e.g., image data, LIDAR data, and/or RADAR data) and from the predicted state (410). Object tracking unit 350 may compare the NIS value to one or more thresholds (412) to determine a mode in which to determine weighting values, then determine the weighting values using the determined mode (414). Object tracking unit 350 may then apply the weighting values to the sensor data and the predicted state to form an estimated state (416).

In this manner, the method of FIG. 6 represents an example of a method of tracking positions of objects near a vehicle, including: receiving values from one or more sensors of a vehicle; calculating a normalized innovation squared (NIS) value using the values from the one or more sensors and a predicted state formed by an object tracking unit of the vehicle; determining weight values to be used to weight the values from the one or more sensors and the predicted state according to a comparison of the NIS value to a threshold; and applying the weight values to the values from the one or more sensors and the predicted state to determine an updated state of positions of objects near the vehicle.

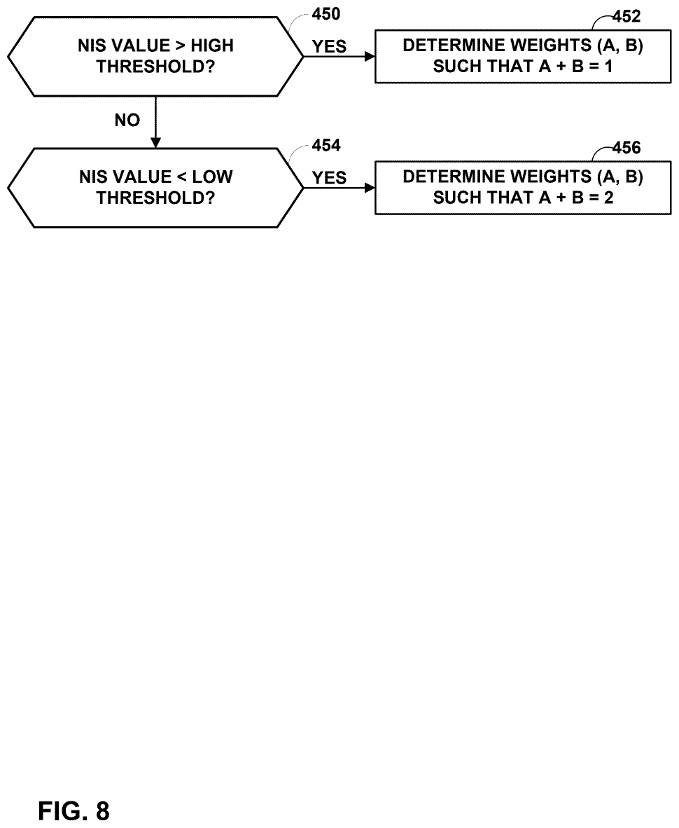

FIG. 8 is a flowchart illustrating an example method for determining weighting values per the techniques of this disclosure. The method of FIG. 8 is also explained with respect to object tracking unit 350 of FIG. 6 for purposes of example and explanation. The method of FIG. 8 generally corresponds to an example of steps 412 and 414 of the method of FIG. 7.

Initially, object tracking unit 350 may determine whether the NIS value is above a high threshold (450). If so (“YES” branch of 450), object tracking unit 350 may determine that the weighting values (omega_a, omega_b, or simply ‘A’ and ‘B’) such that A+B is equal to 1 (452), e.g., per CovInt. However, if the NIS value is not above the high threshold (“NO” branch of 450), object tracking unit 350 may determine whether the NIS value is below a low threshold (454). If so (“YES” branch of 454), object tracking unit 350 may determine the weights (A, B) such that A and B are each equal to 1 (456), e.g., per KF.

Various examples of the techniques of this disclosure are summarized in the following clauses:

Clause 1. A method of tracking positions of objects near a vehicle, the method comprising: receiving values from one or more sensors of a vehicle; calculating a normalized innovation squared (NIS) value using the values from the one or more sensors and a predicted state formed by an object tracking unit of the vehicle; determining weight values to be used to weight the values from the one or more sensors and the predicted state according to a comparison of the NIS value to a threshold; and applying the weight values to the values from the one or more sensors and the predicted state to determine an updated state of positions of objects near the vehicle.

Clause 2. The method of clause 1, wherein the weight values comprise an alpha value and a beta value.

Clause 3. The method of any of clauses 1 and 2, wherein determining the weight values comprises, when the NIS value is above the threshold, determining the weight values according to Covariance Intersection.

Clause 4. The method of any of clauses 1-3, wherein determining the weight values comprises, when the NIS value is below the threshold, determining the weight values according to a Kalman Filter.

Clause 5. The method of any of clauses 1-4, wherein the threshold comprises a first threshold, and wherein determining the weight values comprises determining the weight values according to a comparison of the NIS value to the first threshold and a second threshold.

Clause 6. The method of clause 5, wherein the first threshold is greater than the second threshold, and wherein determining the weight values comprises: when the NIS value is above the first threshold, determining the weight values according to Covariance Intersection; or when the NIS value is below the second threshold, determining the weight values according to a Kalman Filter.

Clause 7. The method of any of clauses 3-6, wherein when determining the weight values according to the Kalman filter, the sum of the weight values is equal to 2.

Clause 8. The method of any of clauses 3-7, wherein when determining the weight values according to the Kalman filter, the weight values are each equal to 1.

Clause 9. The method of any of clauses 3-8, wherein when determining the weight values according to Covariance Intersection, the sum of the weight values is equal to 1.

Clause 10. The method of any of clauses 1-9, wherein the one or more sensors include one or more cameras, light detection and ranging (LIDAR) units, or RADAR units.

Clause 11. The method of any of clauses 1-10, further comprising at least partially controlling the vehicle according to the updated state of the positions of the objects near the vehicle.

Clause 12. The method of any of clauses 1-11, wherein the vehicle comprises one of an automobile or a robot.

Clause 13. A device for tracking positions of objects near a vehicle, the device comprising one or more means for performing the method of any of clauses 1-12.

Clause 14. The device of clause 13, wherein the one or more means comprise a processing system implemented in circuitry.

Clause 15. A device for tracking positions of objects near a vehicle, the device comprising: means for receiving values from one or more sensors of a vehicle; means for calculating a normalized innovation squared (NIS) value using the values from the one or more sensors and a predicted state formed by an object tracking unit of the vehicle; means for determining weight values to be used to weight the values from the one or more sensors and the predicted state according to a comparison of the NIS value to a threshold; and means for applying the weight values to the values from the one or more sensors and the predicted state to determine an updated state of positions of objects near the vehicle.

Clause 16. A computer-readable storage medium having stored thereon instructions that, when executed, cause a processing system to perform the method of any of clauses 1-12.

Clause 17: A method of tracking positions of objects near a vehicle, the method comprising: receiving values from one or more sensors of a vehicle; calculating a normalized innovation squared (NIS) value using the values from the one or more sensors and a predicted state formed by an object tracking unit of the vehicle; determining weight values to be used to weight the values from the one or more sensors and the predicted state according to a comparison of the NIS value to a threshold; and applying the weight values to the values from the one or more sensors and the predicted state to determine an updated state of positions of objects near the vehicle.

Clause 18: The method of clause 17, wherein the weight values comprise an alpha value and a beta value.

Clause 19: The method of clause 17, wherein determining the weight values comprises, when the NIS value is above the threshold, determining the weight values according to Covariance Intersection.

Clause 20: The method of clause 17, wherein determining the weight values comprises, when the NIS value is below the threshold, determining the weight values according to a Kalman Filter.

Clause 21: The method of clause 17, wherein the threshold comprises a first threshold, and wherein determining the weight values comprises determining the weight values according to a comparison of the NIS value to the first threshold and a second threshold.

Clause 22: The method of clause 21, wherein the first threshold is greater than the second threshold, and wherein determining the weight values comprises: when the NIS value is above the first threshold, determining the weight values according to Covariance Intersection; or when the NIS value is below the second threshold, determining the weight values according to a Kalman Filter.

Clause 23: The method of clause 22, wherein when determining the weight values according to the Kalman filter, the sum of the weight values is equal to 2.

Clause 24: The method of clause 22, wherein when determining the weight values according to the Kalman filter, the weight values are each equal to 1.

Clause 25: The method of clause 22, wherein when determining the weight values according to Covariance Intersection, the sum of the weight values is equal to 1.

Clause 26: The method of clause 17, wherein the one or more sensors include one or more cameras, light detection and ranging (LIDAR) units, or RADAR units.

Clause 27: The method of clause 17, further comprising providing assistance to a driver of the vehicle according to the updated state of the positions of the objects near the vehicle.

Clause 28: A device for tracking positions of objects near a vehicle, the device comprising: a memory; and a processing system implemented in circuitry, coupled to the memory, and configured to: receive values from one or more sensors of a vehicle; calculate a normalized innovation squared (NIS) value using the values from the one or more sensors and a predicted state formed by an object tracking unit of the vehicle; determine weight values to be used to weight the values from the one or more sensors and the predicted state according to a comparison of the NIS value to a threshold; and apply the weight values to the values from the one or more sensors and the predicted state to determine an updated state of positions of objects near the vehicle.

Clause 29: The device of clause 28, wherein the weight values comprise an alpha value and a beta value.

Clause 30: The device of clause 28, wherein to determine the weight values, the processing system is configured to, when the NIS value is above the threshold, determine the weight values according to Covariance Intersection.

Clause 31: The device of clause 28, wherein to determine the weight values, the processing system is configured to, when the NIS value is below the threshold, determining the weight values according to a Kalman Filter.

Clause 32: The device of clause 28, wherein the threshold comprises a first threshold, and wherein to determine the weight values, the processing system is configured to determine the weight values according to a comparison of the NIS value to the first threshold and a second threshold.

Clause 33: The device of clause 32, wherein the first threshold is greater than the second threshold, and wherein to determine the weight values, the processing system is configured to: when the NIS value is above the first threshold, determining the weight values according to Covariance Intersection; or when the NIS value is below the second threshold, determining the weight values according to a Kalman Filter.

Clause 34: The device of clause 28, wherein the one or more sensors include one or more cameras, light detection and ranging (LIDAR) units, or RADAR units.

Clause 35: The device of clause 28, wherein the processing system is further configured to provide assistance to a driver of the vehicle according to the updated state of the positions of the objects near the vehicle.

Clause 36: A computer-readable storage medium having stored thereon instructions that, when executed, cause a processing system to: receive values from one or more sensors of a vehicle; calculate a normalized innovation squared (NIS) value using the values from the one or more sensors and a predicted state formed by an object tracking unit of the vehicle; determine weight values to be used to weight the values from the one or more sensors and the predicted state according to a comparison of the NIS value to a threshold; and apply the weight values to the values from the one or more sensors and the predicted state to determine an updated state of positions of objects near the vehicle.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method of tracking positions of objects near a vehicle, the method comprising:
receiving values from one or more sensors of a vehicle;
calculating a normalized innovation squared (NIS) value using the values from the one or more sensors and a predicted state formed by an object tracking unit of the vehicle;
determining weight values to be used to weight the values from the one or more sensors and the predicted state according to a comparison of the NIS value to a threshold; and
applying the weight values to the values from the one or more sensors and the predicted state to determine an updated state of positions of objects near the vehicle.

2. The method of claim 1, wherein the weight values comprise an alpha value and a beta value.

3. The method of claim 1, wherein determining the weight values comprises, when the NIS value is above the threshold, determining the weight values according to Covariance Intersection.

4. The method of claim 1, wherein determining the weight values comprises, when the NIS value is below the threshold, determining the weight values according to a Kalman Filter.

5. The method of claim 1, wherein the threshold comprises a first threshold, and wherein determining the weight values comprises determining the weight values according to a comparison of the NIS value to the first threshold and a second threshold.

6. The method of claim 5, wherein the first threshold is greater than the second threshold, and wherein determining the weight values comprises:
when the NIS value is above the first threshold, determining the weight values according to Covariance Intersection; or
when the NIS value is below the second threshold, determining the weight values according to a Kalman Filter.

7. The method of claim 6, wherein when determining the weight values according to the Kalman filter, the sum of the weight values is equal to 2.

8. The method of claim 6, wherein when determining the weight values according to the Kalman filter, the weight values are each equal to 1.

9. The method of claim 6, wherein when determining the weight values according to Covariance Intersection, the sum of the weight values is equal to 1.

10. The method of claim 1, wherein the one or more sensors include one or more cameras, light detection and ranging (LIDAR) units, or RADAR units.

11. The method of claim 1, further comprising providing assistance to a driver of the vehicle according to the updated state of the positions of the objects near the vehicle.

12. A device for tracking positions of objects near a vehicle, the device comprising:
a memory; and
a processing system implemented in circuitry, coupled to the memory, and configured to:
receive values from one or more sensors of a vehicle;
calculate a normalized innovation squared (NIS) value using the values from the one or more sensors and a predicted state formed by an object tracking unit of the vehicle;
determine weight values to be used to weight the values from the one or more sensors and the predicted state according to a comparison of the NIS value to a threshold; and
apply the weight values to the values from the one or more sensors and the predicted state to determine an updated state of positions of objects near the vehicle.

13. The device of claim 12, wherein the weight values comprise an alpha value and a beta value.

14. The device of claim 12, wherein to determine the weight values, the processing system is configured to, when the NIS value is above the threshold, determine the weight values according to Covariance Intersection.

15. The device of claim 12, wherein to determine the weight values, the processing system is configured to, when the NIS value is below the threshold, determining the weight values according to a Kalman Filter.

16. The device of claim 12, wherein the threshold comprises a first threshold, and wherein to determine the weight values, the processing system is configured to determine the weight values according to a comparison of the NIS value to the first threshold and a second threshold.

17. The device of claim 16, wherein the first threshold is greater than the second threshold, and wherein to determine the weight values, the processing system is configured to:
when the NIS value is above the first threshold, determining the weight values according to Covariance Intersection; or
when the NIS value is below the second threshold, determining the weight values according to a Kalman Filter.

18. The device of claim 12, wherein the one or more sensors include one or more cameras, light detection and ranging (LIDAR) units, or RADAR units.

19. The device of claim 12, wherein the processing system is further configured to provide assistance to a driver of the vehicle according to the updated state of the positions of the objects near the vehicle.

20. A computer-readable storage medium having stored thereon instructions that, when executed, cause a processing system to:
receive values from one or more sensors of a vehicle;
calculate a normalized innovation squared (NIS) value using the values from the one or more sensors and a predicted state formed by an object tracking unit of the vehicle;
determine weight values to be used to weight the values from the one or more sensors and the predicted state according to a comparison of the NIS value to a threshold; and
apply the weight values to the values from the one or more sensors and the predicted state to determine an updated state of positions of objects near the vehicle.
